(19) United States
(12) Patent Application Publication
(10) Pub. No.: US 2024/0378123 A1
(43) Pub. Date: Nov. 14, 2024

(54) METHODS AND APPARATUSES FOR MANAGING MULTI-ZONE DATA CENTER FAILURES

(71) Applicant: NAVER CORPORATION, Seongnam-si (KR)

(72) Inventors: Kyu Jae LEE, Seongnam-si (KR); Ki-Yeul LEE, Seongnam-si (KR); Sang Hoon HAN, Seongnam-si (KR)

(73) Assignee: NAVER CORPORATION, Seongnam-si (KR)

(21) Appl. No.: 18/658,179

(22) Filed: May 8, 2024

(30) Foreign Application Priority Data
May 8, 2023 (KR) 10-2023-0058931

(51) Int. Cl. G06F 11/16

(52) U.S. Cl. CPC G06F 11/1658; G06F 2201/805

(57) ABSTRACT

A method for managing data center failures, executed by one or more processors of a leader management node, includes allocating a first data node among a first plurality of data nodes a master data node, the first plurality of data nodes being in a first data center, allocating a second data node among the first plurality of data nodes as a first backup data node, allocating one among a second plurality of data nodes as a second backup data node, the second plurality of data nodes being in a second data center, and the first data center and the second data center being located in different regions, and setting a data replication mode between the master data node, the first backup data node and the second backup data node, the data replication mode being selected from a set of modes including a first mode and a second mode.

### CROSS-REFERENCE TO RELATED APPLICATION

This application claims priority to Korean Patent Application No. 10-2023-0058931, filed in the Korean Intellectual Property Office on May 8, 2023, the entire contents of which are hereby incorporated by reference.

### BACKGROUND

### Field

The present disclosure relates to a method and an apparatus for managing multi-zone data center failures, and more specifically, to a method and an apparatus for setting a method of data replication between data nodes in the multi-zone data center and managing failures of the data nodes in the multi-zone data center.

### Description of Related Art

For Internet-based services, it is important to maintain high availability of corresponding systems to ensure that users have continuous access to the services, and to maintain data integrity and security. A method of generating multiple copies of the same data is widely used to maintain high availability of the system.

However, if a corresponding system, such as an Internet Data Center (IDC), fails due to disaster conditions such as fire, earthquake, flood, etc., the provision of Internet-based services may be interrupted, and irreparable damage such as data loss may occur. For example, the 2020 fire at an IDC in South Korea caused major disruptions to a variety of Internet services, including banking, email, and online gaming, affecting millions of users across the country.

### SUMMARY

In order to solve one or more challenges (e.g., the challenges described above and/or other challenges not explicitly described herein), the present disclosure provides a method for, a non-transitory computer-readable recording medium storing instructions for, and an apparatus (system) for managing a multi-zone data center failure. Some example embodiments provide for failure management methods that maintain higher availability in the event of an IDC failure.

The present disclosure may be implemented in a variety of ways, including a method, a system (apparatus), or a non-transitory computer-readable recording medium storing instructions.

A method for managing data center failures is provided, which may be executed by one or more processors of a leader management node, and include allocating a first data node among a first plurality of data nodes a master data node, the first plurality of data nodes being in a first data center, allocating a second data node among the first plurality of data nodes as a first backup data node, allocating one among a second plurality of data nodes as a second backup data node, the second plurality of data nodes being in a second data center, and the first data center and the second data center being located in different regions, and setting a data replication mode between the master data node, the first backup data node and the second backup data node, the data replication mode being selected from a set of modes including a first mode and a second mode.

There is provided a non-transitory computer-readable recording medium storing instructions for executing the method on a computer.

A management node is provided, which may include a memory storing one or more computer-readable programs, and one or more processors connected to the memory and configured to execute the one or more computer-readable programs to cause the management node to allocate a first data node among a first plurality of data nodes as a master data node, the first plurality of data nodes being in a first data center, allocate a second data node among the first plurality of data nodes as a first backup data node, allocate one among a second plurality of data nodes as a second backup data node, the second plurality of data nodes being in a second data center, and the first data center and the second data center being located in different regions, and set a data replication mode between the master data node, the first backup data node and the second backup data node, the data replication mode being selected from a set of modes including a first mode and a second mode.

According to some examples of the present disclosure, because the leader management node and the backup management node connected to the leader management node are located in different data centers, failover may be performed without the access address when one data center fails.

According to some examples of the present disclosure, when a data node fails, failover is possible at a higher speed.

According to some examples of the present disclosure, a user or an administrator may select the method of data replication between the first mode and the second mode, and thus efficiently utilize the advantages of the data synchronous replication method or the asynchronous replication method according to the purpose of (e.g., intended) use of the cluster, etc.

The effects of the present disclosure are not limited to the effects described above, and other effects not mentioned will be able to be clearly understood by those of ordinary skill in the art (referred to as “those skilled in the art”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but are not limited thereto, in which:

FIG. 1 illustrates a plurality of management nodes and a plurality of data nodes in a plurality of data centers;

FIG. 2 is a schematic diagram illustrating a configuration in which an information processing system is communicably coupled to a plurality of user terminals to provide services associated with a particular cluster in the multi-zone data center;

FIG. 3 is a block diagram of an internal configuration of the user terminal and the information processing system;

FIG. 4 illustrates an example of data transmission and reception between nodes when the first mode is set for the data replication method;

FIG. 5 illustrates an example in which a new master data node is elected when the first mode is set for the data replication method;

FIG. 6 illustrates an example in which a new master data node is elected when a failure occurs in all data nodes in the first data center;

FIG. 7 illustrates an example of data transmission and reception between nodes when the second mode is set for the data replication method;

FIG. 8 illustrates an example in which a new master data node is elected when the second mode is set for the data replication method;

FIG. 9 illustrates an example in which a new master data node is elected when a failure occurs in all data nodes in the first data center;

FIG. 10 is a flowchart provided to explain a method for managing multi-zone data center failures.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same, similar or corresponding components are assigned the same reference numerals (or similar reference numerals). In addition, in the following description of various examples, duplicate descriptions of the same, similar or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

The singular forms “a,” “an,” and “the” as used herein are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of non-transitory processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor is able to read information from and/or write information to the memory. The memory integrated with the processor is in electronic communication with the processor.

In the present disclosure, “node” may refer to an apparatus or component that participates in operation, communication or resource management, etc., of a system in a network or system that performs a specific task or function. For example, the node may include physical machines, virtual machines, storage devices, network switches, routers, or other computing elements, interconnected to each other and working together to provide services, share resources, process data, etc.

In the present disclosure, “data center” or “Internet Data Center (IDC)” may refer to a facility that accommodates Information Technology (IT) infrastructure such as servers, storage systems and/or networking equipment to store, process, and manage digital data.

In the present disclosure, “region” may refer to a geographically distinct area where a data center is located. For example, if there is one data center at a physical location that is at least a certain distance (e.g., a certain geographical distance) away from another data center, then each of the data centers may be described as being located in different regions. According to some example embodiments, different regions may be physically located in different political jurisdictions (e.g., may be separated by a geographic political barrier), but some aspects are not limited thereto.

In the present disclosure, a “master data node” may refer to a basic or central component in a distributed computing system that stores, processes, and manages data in a system or cluster. For example, a master data node may be a component that ensures (or increases the likelihood of) efficient and consistent data management throughout the system through data storage, processing and synchronization, and communication with other nodes or components in the network.

In the present disclosure, “backup data node” may refer to an auxiliary or redundant component in a distributed computing system that stores a copy of original data (e.g., data in “master data node”). For example, the backup data node may perform tasks such as restoring the original data in case of problems with (e.g., failure of) the underlying data storage or processing components (e.g., master data node), such as data loss, system error, or other disruption, providing a means for maintaining and managing system functions, etc.

In the present disclosure, “learner type” may refer to a type of backup data node in which data replication is performed using an asynchronous replication method with a master data node and which is not elected as a new master data node in the event of a failure in the master data node. The learner type backup data node may be located in a data center in a different region from the master data node.

In the present disclosure, “cluster” may refer to a group of interconnected nodes or computing resources that work together to perform a specific task or provide a specific service. For example, the cluster may include a management node, a master data node, and a backup data node, and if a failure or problem occurs in the master data node in the cluster, a backup data node in the same cluster (or a similar cluster) may intervene to maintain system functionality and ensure (or improve) data integrity.

In the present disclosure, “acknowledgement (ACK)” may refer to an acknowledgement, message, or signal, etc., that is transmitted from the client or node to the counter client or node that transmitted data or requests so as to confirm successful data reception or to indicate successful processing of the request.

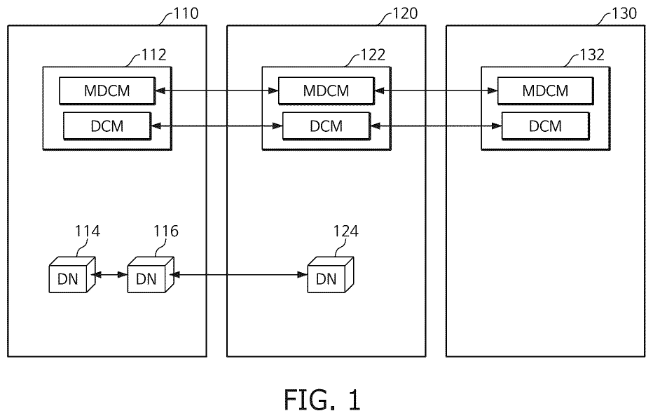

FIG. 1 illustrates a plurality of management nodes 112, 122, and 132, and a plurality of data nodes 114, 116, and 124, in a plurality of data centers 110, 120, and 130. FIG. 1 illustrates three data centers, three management nodes, and three data nodes, but aspects are not limited thereto, and there may be any number of data centers, management nodes, and data nodes. The plurality of data centers 110, 120, and 130 may be data centers located in different regions.

The plurality of management nodes 112, 122, and 132 (or a leader management node) may generate or manage a cluster including one or more master data nodes and one or more backup data nodes. For example, the plurality of management nodes 112, 122, and 132 (or a leader management node) may monitor a failure of a data node in the cluster, and in case of failure, cope with the failure by changing one of the backup data nodes to the master data node.

Each of the plurality of management nodes 112, 122, and 132 may be located in a respective one among the plurality of different data centers 110, 120, and 130. In this case, one of the plurality of management nodes 112, 122, and 132 may correspond to the leader management node, and the management nodes other than the leader management node may be the backup management nodes (or secondary management nodes) connected to the leader management node. That is, the leader management node and the backup management node may be included in the data centers located in different regions.

The leader management node and the backup management nodes may be synchronized using the Raft Protocol. For example, the Raft Protocol may be implemented using a Raft consensus algorithm. As the leader management node and the backup management nodes are synchronized using the Raft Protocol, at least one of the backup management nodes may be changed to a new leader management node in response to the failure in the leader management node. For example, if the leader management node fails, a candidate node of the backup management nodes may transmit a vote request message to the other nodes and be elected as a new leader management node if it receives votes from a majority of the management nodes.

Each of the plurality of management nodes 112, 122, and 132 may include a Machine and Data Center Manager (MDCM) server and a Data Center Managers (DCM) server. Specifically, the DCM server may manage a partition group or cluster including a master data node and a backup data node, and the MDCM server may manage physical machine (PM) information and DCM server information.

The leader management node (e.g., 112) may be allocated with one of the plurality of data nodes 116 in the first data center 110 as a master data node, and may be allocated with another one data node 114 of the plurality of data nodes as a first backup data node. Likewise, the leader management node may be allocated with one data node 124 of a plurality of data nodes in the second data center 120 as a second backup data node associated with the master data node 116.

The leader management node may set a first mode or a second mode for the method of data replication between the master data node 116, the first backup data node 114, and/or the second backup data node 124. The method of data replication between the master data node 116, the first backup data node 114, and/or the second backup data node 124 may be set based on an input (e.g., administrator input) associated with the data replication method. In the event of a failure, the first mode of the data replication method may prioritize data stability over minimization (or reduction) of latency in providing service, and the second mode may prioritize minimization (or reduction) of latency in providing service over data stability.

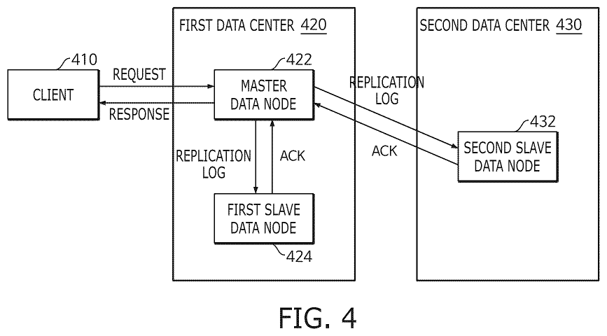

Depending on the set mode of data replication method, the type of backup data node, the data synchronization method, and the method of master election in the event of the master data node failure may vary. This will be described below in detail with reference to FIGS. 4 to 9.

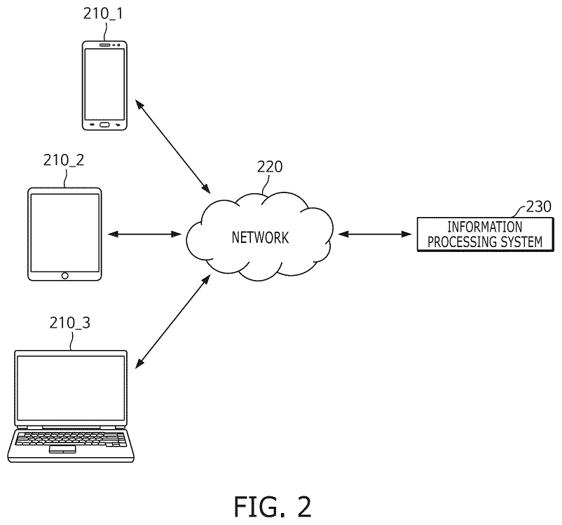

FIG. 2 is a schematic diagram illustrating a configuration in which an information processing system 230 is communicably coupled to a plurality of user terminals 210_1, 210_2, and 210_3 to provide services associated with a particular cluster in the multi-zone data center. The information processing system 230 may include a system(s) capable of providing a service associated with a specific cluster in the multi-zone data center. The information processing system 230 may include one or more server devices and/or databases, or one or more distributed computing devices and/or distributed databases based on cloud computing services, which are capable of storing, serving, and executing computer-executable programs (e.g., downloadable applications) and data associated with a service associated with a specific cluster in the multi-zone data center. For example, the information processing system 230 may include a plurality of IDCs.

The service associated with the specific cluster in the multi-zone data center provided by the information processing system 230 may be provided to the user through an application, etc., installed in each of the plurality of user terminals 210_1, 210_2, and 210_3. In this case, the service associated with the specific cluster in the multi-zone data center may refer to a service that allows a user to request and receive data in the multi-zone data center.

The plurality of user terminals 210_1, 210_2, and 210_3 may communicate with the information processing system 230 through a network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, etc.) that may be included in the network 220 as well as short-range wireless communication between the user terminals 210_1, 210_2, and 210_3.

For example, the plurality of user terminals 210_1, 210_2, and 210_3 may transmit a request to the information processing system 230 through the network 220, and the information processing system 230 may receive the request and transmit a response corresponding to the request to the plurality of user terminals 210_1, 210_2, and 210_3. For example, if the user terminal 210_1 transmits an operation of clicking a link to a specific website to the information processing system 230 (or a master data node in the information processing system 230) (requesting), the information processing system 230 (or a master data node in the information processing system 230) may transmit content included in the website to the user terminal 210_1 (responding). The content included in the website may be stored in the data node in a multi-zone data center.

If a master data node in the information processing system 230 fails, one of the backup data nodes may be quickly changed to a new master data node. The plurality of user terminals 210_1, 210_2, and 210_3 transmit a request to the new master data node, and the new master data node transmits a response to the plurality of user terminals 210_1, 210_2, and 210_3, so that the information processing system 230 may provide the service to the plurality of user terminals 210_1, 210_2, and 210_3 after a small latency even when a failure occurs.

In FIG. 2, the mobile phone terminal 210_1, the tablet terminal 210_2, and the PC terminal 210_3 are illustrated as examples of user terminals, but aspects are not limited thereto, and each of the user terminals 210_1, 210_2, and 210_3 may be any computing device capable of wired and/or wireless communication and on which an application associated with data in the multi-zone data center, etc., may be installed and executed. For example, the user terminal may include a smartphone, mobile phone, navigation system, computer, notebook computer, digital broadcasting terminal, Personal Digital Assistants (PDA), Portable Multimedia Player (PMP), tablet PC, game console, wearable device, Internet of things (IoT) device, virtual reality (VR) device, augmented reality (AR) device, etc. In addition, while FIG. 2 illustrates that three user terminals 210_1, 210_2, and 210_3 are in communication with the information processing system 230 through the network 220, aspects are not limited thereto, and a different number of user terminals may be configured to be in communication with the information processing system 230 through the network 220.

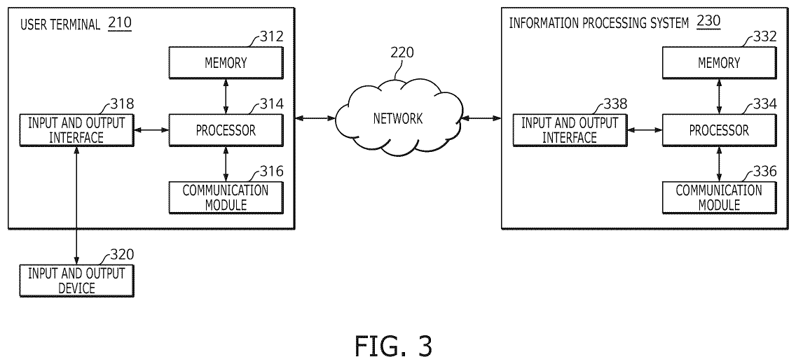

FIG. 3 is a block diagram of an internal configuration of the user terminal 210 and the information processing system 230. The user terminal 210 may refer to any computing device that is capable of executing an application, etc., associated with a specific cluster in the multi-zone data center and also capable of wired/wireless communication, and may include the mobile phone terminal 210_1, the tablet terminal 210_2, the PC terminal 210_3, etc., of FIG. 2, for example. As illustrated, the user terminal 210 may include a memory 312, a processor 314, a communication module 316, and/or an input and output interface 318. Likewise, the information processing system 230 may include a memory 332, a processor 334, a communication module 336, and/or an input and output interface 338. As illustrated in FIG. 3, the user terminal 210 and the information processing system 230 may be configured to communicate information, data, etc., through the network 220 using respective communication modules 316 and 336. In addition, an input and output device 320 may be configured to input information, data, etc., to the user terminal 210, or output information, data, etc., generated from the user terminal 210 through the input and output interface 318. According to some example embodiments, the information processing system 230 may be a management node (e.g., a leader management node) among the plurality of management nodes 112, 122 and 132.

Each of the memories 312 and 332 may include any non-transitory computer-readable recording medium. Each of the memories 312 and 332 may include a permanent mass storage device such as a read only memory (ROM), disk drive, solid state drive (SSD), flash memory, etc. As another example, a non-destructive mass storage device such as a ROM, SSD, flash memory, disk drive, etc., may be included in the user terminal 210 and/or the information processing system 230 as a separate permanent storage device that is distinct from the memory (e.g., the memories 312 and 332). In addition, each of the memories 312 and 332 may store an operating system and/or at least one program code (e.g., code for an application associated with a specific cluster in the multi-zone data center, etc.).

These software components (e.g., the operating system and/or the at least one program code) may be loaded from a non-transitory computer-readable recording medium separate from the memories 312 and 332. Such a separate non-transitory computer-readable recording medium may include a non-transitory recording medium directly connectable to the user terminal 210 and/or the information processing system 230, and may include a non-transitory computer-readable recording medium such as a floppy drive, a disk, a tape, a DVD/CD-ROM drive, a memory card, etc., for example. As another example, the software components may be loaded into the memories 312 and 332 through the communication modules 316 and 336, respectively, rather than the non-transitory computer-readable recording medium. For example, at least one program may be loaded into the memories 312 and 332 based on a computer program (e.g., application associated with a specific cluster in the multi-zone data center, etc.) installed by files provided through the network 220 by a developer or by a file distribution system that distributes application installation files.

Each of the processors 314 and 334 may be configured to process the instructions of the computer program by performing basic arithmetic, logic, and input and output operations. The instructions may be respectively provided to the processors 314 and 334 from the memories 312 and 332 or the communication modules 316 and 336. For example, the processors 314 and 334 may be configured to execute the received instructions according to a program code stored in a recording device such as the memories 312 and 332, respectively. According to some example embodiments, each of the processors 314 and 334 may be implemented by one or more processors, a microprocessor, a central processing unit (CPU), a processor core, a multi-core processor, a multiprocessor, etc.

The communication modules 316 and 336 may provide a configuration or function for the user terminal 210 and the information processing system 230 to communicate with each other through the network 220, and may provide a configuration or function for the user terminal 210, the information processing system 230, etc., to communicate with another user terminal or another system (e.g., a separate cloud system, etc.). For example, the requests or data generated by the processor 314 of the user terminal 210 according to the program code stored in the recording device such as the memory 312, or the like, may be transmitted to the information processing system 230 through the network 220 under the control of the communication module 316. Conversely, a control signal or command provided under the control of the processor 334 of the information processing system 230 may be received by the user terminal 210 through the communication module 316 of the user terminal 210 and through the communication module 336 and the network 220.

The input and output interface 318 may be a means for interfacing with the input and output device 320. According to some example embodiments, the input and output device 320 may include an input device and/or an output device. As an example, the input device may include a device such as a camera including an audio sensor and/or an image sensor, a keyboard, a microphone, a mouse, etc., and the output device may include a device such as a display, a speaker, a haptic feedback device, etc. As another example, the input and output interface 318 may be a means for interfacing with a device such as a touch screen, etc., that integrates a configuration or function for performing both inputting and outputting. While FIG. 3 illustrates that the input and output device 320 is not included in the user terminal 210, aspects are not limited thereto, and the input and output device 320 may be configured as one (e.g., a single) device with the user terminal 210. In addition, the input and output interface 338 of the information processing system 230 may be a means for interfacing with a device (not illustrated) for inputting or outputting that may be connected to, or included in the information processing system 230. While FIG. 3 illustrates the input and output interfaces 318 and 338 as the components configured separately from the processors 314 and 334, aspects are not limited thereto, and the input and output interfaces 318 and 338 may be configured to be included in the processors 314 and 334, respectively.

Each of the user terminal 210 and the information processing system 230 may include more components than illustrated in FIG. 3. Illustration of such other related components has been omitted for clarity of description. By way of example, however, the user terminal 210 may be implemented to include at least a part of the input and output device 320 described above. In addition, the user terminal 210 may further include another component such as a transceiver, a global positioning system (GPS) module, a camera, various sensors, a database, etc. For example, if the user terminal 210 is a smartphone, it may generally include components included in the smartphone, and for example, it may be implemented such that various components such as an acceleration sensor, a gyro sensor, a microphone module, a camera module, various physical buttons, buttons using a touch panel, input and output ports, a vibrator for vibration, etc., are further included in the user terminal 210.

The processor 314 of the user terminal 210 may be configured to run an application or web browser application that provides a service associated with a specific cluster in the multi-zone data center. A program code associated with the above application may be loaded into the memory 312 of the user terminal 210. While the application is running, the processor 314 of the user terminal 210 may receive information and/or data provided from the input and output device 320 through the input and output interface 318, and/or receive information and/or data from the information processing system 230 through the communication module 316, and process the received information and/or data and store it in the memory 312. In addition, such information and/or data may be provided to the information processing system 230 through the communication module 316.

While the application is running, the processor 314 may receive voice data, text, image data, video, and the like, input or selected through the input device such as a camera, a microphone, and the like, that includes a touch screen, a keyboard, an audio sensor and/or an image sensor connected to the input and output interface 318, and store the received voice data, text, image data, and/or video, or the like, in the memory 312, or provide it to the information processing system 230 through the communication module 316 and the network 220. The processor 314 may receive a user input of selecting a graphic object displayed on the display, which is input through the input device, and provide a request/data corresponding to the received user input to the information processing system 230 through the network 220 and the communication module 316.

The processor 314 of the user terminal 210 may transmit and output the information and/or data to the input and output device 320 through the input and output interface 318. For example, the processor 314 of the user terminal 210 may output the processed information and/or data through the output device such as a device capable of outputting a display (e.g., a touch screen, a display, etc.), a device capable of outputting a voice (e.g., speaker), etc.

The processor 334 of the information processing system 230 may be configured to manage, process, and/or store information, data, etc., received from a plurality of user terminals 210, a plurality of external systems, etc. The information and/or data processed by the processor 334 may be provided to the user terminal 210 through the communication module 336 and the network 220.

FIG. 4 illustrates an example of data transmission and reception between nodes when the first mode is set for the data replication method. A user or an administrator may select the first mode for the data replication method (e.g., method of data replication between data nodes in a specific cluster) or change the second mode to the first mode. The first mode may be a data replication method that prioritizes data stability in the event of a failure over minimization (or reduction) of latency in providing the Internet service.

If the first mode is set for the data replication method, a first backup data node included in a first data center 420 including a master data node 422 may be set as a first slave data node 424, and a second backup data node in a second data center 430 located in a different region from the first data center 420 may be set as a second slave data node 432. In this case, data replication between each of the slave data nodes 424 and 432 and the master data node 422 may be performed with a synchronous replication method.

In response to receiving a request from a client 410, the master data node 422 may transmit a replication log to the first slave data node 424 and the second slave data node 432. In this case, since data replication on all slave data nodes is done with the synchronous replication method, the master data node 422 may output a response associated with the request to the client 410 only after receiving an acknowledgement (ACK) from both the first slave data node 424 and the second slave data node 432. This configuration may ensure (or improve) data reliability, although there may be some latency when providing service.

Each of the slave data nodes 424 and 432 may be included as a new master candidate for the master election that may be performed when the master data node 422 fails. When it is determined that the first slave data node 424 is located in the same data center (e.g., the first data center 420) as (or a similar data center to) the master data node 422 and the second slave data node 432 is located in the second data center 430 different from the master data node, priority may be assigned to the first slave data node 424 in the master election. According to some example embodiments, the client 410 may be implemented by the user terminal 210, and/or each of the master data node 422, the first slave data node 424 and/or the second slave data node 432 may be implemented by a device that is the same as or similar to the information processing system 230.

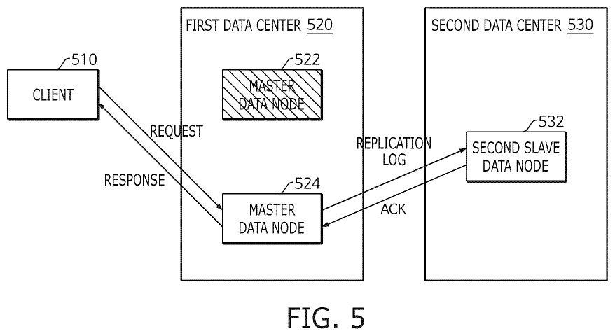

FIG. 5 illustrates an example in which a new master data node 524 is elected when the first mode is set for the data replication method. In response to determining that an existing master data node 522 fails, one of the slave data nodes 424 and 432 of FIG. 4 included in the new master candidate may be automatically changed to the new master data node without an administrator input (e.g., without receiving an input from an external source, such as a user or administrator). Determining whether a failure occurs in the master data node 522 and electing a master may be performed by the management node.

In the master election, the priority may be assigned to the slave data nodes located in the same data center as (or a similar data center to) the master data node 522. For this purpose (or function), the management node may store information on the data center where each data node is located. FIG. 5 illustrates an example in which the first slave data node 424 of FIG. 4 is elected as the new master data node 524 according to random election or priority assigned.

The data replication between a second slave data node 532 and the new master data node 524 may be performed with a synchronous replication method. For example, in response to receiving a request from a client 510, the new master data node 524 may transmit the replication log to the second slave data node 532, receive an acknowledgement (ACK) from the second slave data node 532, and output a response associated with the request to the client 510. According to some example embodiments, the management node may be implemented by the information processing system 230. According to some example embodiments, the client 510, the master data node 522, the master data node 524 and/or the second slave data node 532 may be the same as (or similar to) the client 410, the master data node 422, the first slave data node 424 and/or the second slave data node 432, respectively.

In FIG. 5, data may be recovered immediately (or promptly) despite the failure, because before the failure in the master data node 522, the data replication has been performed with the synchronous replication method to always keep the second slave data node 532 and the new master data node 524 up to date.

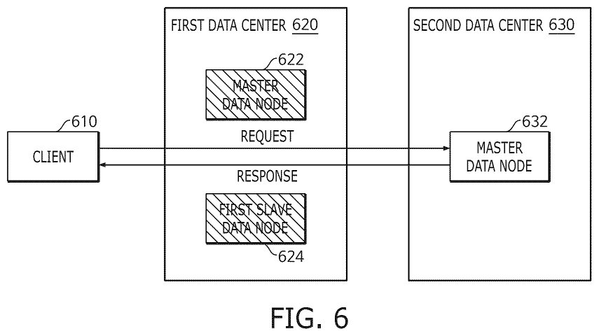

FIG. 6 illustrates an example in which a new master data node 632 is elected when a failure occurs in all data nodes (e.g., data nodes 622 and 624) in the first data center 620. As illustrated, when the master data node 622 and the first slave data node 624 included in the first data center 620 fail, a second slave data node included in a second data center 630 located in an different region from the first data center 620 may be elected as the new master data node 632. For example, if a disaster occurs in the first data center 620, both the master data node 622 and the first slave data node 624 may fail. The new master data node 632 may output a response associated with the request to a client 610 in response to receiving the request from the client 610.

Data may be recovered immediately (or promptly) despite the failure in the entire first data center 620, because before the failure in the master data node 622 and the second slave data node, the data replication has been performed with the synchronous replication method for the first slave data node 624 and the new master data node 632 to always keep the data up to date. That is, this configuration may ensure (or improve) data stability, although there may be some latency in providing service in normal times. According to some example embodiments, the client 610, the master data node 622, the first slave data node 624 and/or the master data node 632 may be the same as (or similar to) the client 410, the master data node 422, the first slave data node 424 and/or the second slave data node 432, respectively.

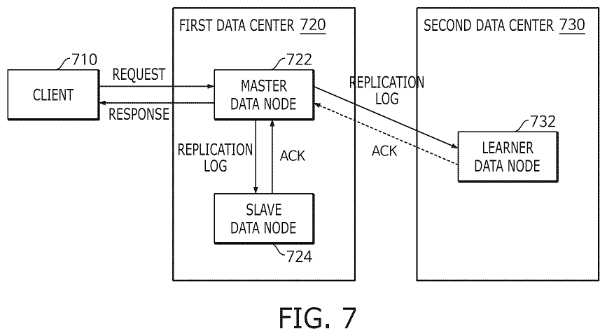

FIG. 7 illustrates an example of data transmission and reception between nodes when the second mode is set for the data replication method. A user or an administrator may select the second mode for the data replication method (e.g., method of data replication between data nodes in a specific cluster) or change the first mode to the second mode. The second mode may be the data replication method that prioritizes minimization (or reduction) of latency in providing service over data stability in the event of a failure.

If the second mode is set for the data replication method, a first backup data node included in a first data center 720 including a master data node 722 may be set as a slave data node 724, and a second backup data node included in a second data center 730 located in a different region from the first data center 720 may be set as a learner data node 732. In this case, data replication between the slave data node 724 and the master data node 722 may be performed with the synchronous replication method, and data replication between the learner data node 732 and the master data node 722 may be performed with the asynchronous replication method.

In response to receiving a request from a client 710, the master data node 722 may transmit a replication log to the slave data node 724 and the learner data node 732. In this case, in response to receiving an acknowledgement (ACK) from the slave data node 724, the master data node 722 may output a response associated with the request to the client 710. That is, a response associated with the request may be output to the client 710 regardless of whether the ACK is received from the learner data node 732. According to some example embodiments, the master data node 722 may output the response associated with the request in response to receiving the ACK from the slave data node 724 and without receiving the ACK from the learner data node 732. This configuration may reduce the latency in providing service, although data stability may decrease. That is, the second mode may be suitable for a service for cache purposes (or for use as cache), etc., which requires (or involves) a short response time and may tolerate some data loss at the time of failure. For example, in the second mode, data loss corresponding to several tens of ms may occur in 1 second in case of failure.

The slave data node 724 may be included as a new master candidate for the master election that may be performed when the master data node 722 fails, but the learner data node 732 may not be included as a new master candidate for the master election. According to some example embodiments, the client 710 may be implemented by the user terminal 210, and/or each of the master data node 722, the slave data node 724 and/or the learner data node 732 may be implemented by a device that is the same as or similar to the information processing system 230.

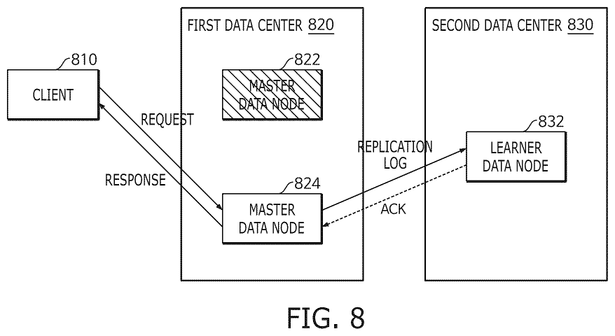

FIG. 8 illustrates an example in which a new master data node 824 is elected when the second mode is set for the data replication method. In response to determining that an existing master data node 822 fails, the slave data node 724 of FIG. 7 included in the new master candidate may be automatically changed to the new master data node 824 without an administrator input (e.g., without receiving an input from an external source, such as a user or administrator). This is because a learner data node 832 is excluded from the master election. Determining whether a failure occurs in the master data node 822 and electing a master may be performed by the management node.

The data replication between the learner data node 832 and the new master data node 824 may also be performed with the asynchronous replication method. For example, in response to receiving a request from a client 810, the new master data node 824 may transmit a replication log to the learner data node 832 and output a response associated with the request to the client 810 regardless of whether an acknowledgement (ACK) is received from the learner data node 832. According to some example embodiments, the management node may be implemented by the information processing system 230. According to some example embodiments, the client 810, the master data node 822, the master data node 824 and/or the learner data node 832 may be the same as (or similar to) the client 710, the master data node 722, the slave data node 724 and/or the learner data node 732, respectively.

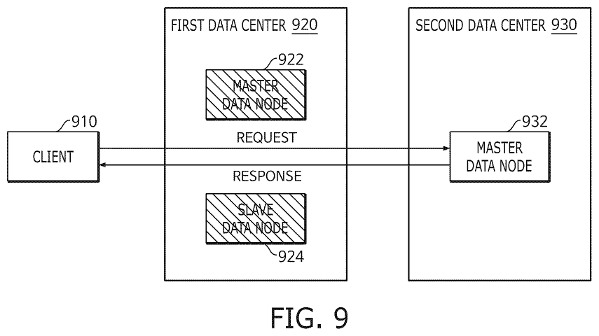

FIG. 9 illustrates an example in which a new master data node 932 is elected when a failure occurs in all data nodes (e.g., data nodes 922 and 924) in the first data center 920. As illustrated, if it is determined that a failure occurs in both the master data node 922 and the first slave data node 924 included in the first data center 920, a message querying whether or not to change the learner data node 832 of FIG. 8 to a new master data node may be transmitted to an administrator (or external device), etc. For example, if a disaster occurs in the first data center 920, both the master data node 922 and the first slave data node 924 may fail.

In response to receiving a request (or administrator input) to change the learner data node 832 of FIG. 8 to a new master data node, the learner data node 832 of FIG. 8 may be elected as the new master data node 932. If both the master data node 922 and the first slave data node 924 fail in the second mode, the learner data node may be changed to a new master data node after administrator verification, and this is because the learner data node has been performing data replication with the asynchronous replication method, which could cause some data loss. The administrator may determine whether to change the learner data node to a new master data node with some data loss. The new master data node 932 may output a response associated with the request to a client 910 in response to receiving the request from the client 910. According to some example embodiments, the client 910, the master data node 922, the slave data node 924 and/or the master data node 932 may be the same as (or similar to) the client 710, the master data node 722, the slave data node 724 and/or the learner data node 732, respectively.

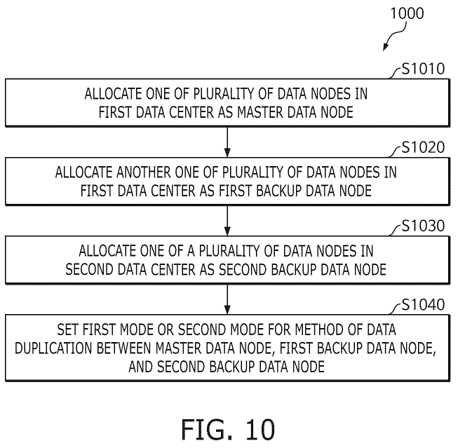

FIG. 10 is a flowchart provided to explain a method 1000 for managing multi-zone data center failures. The method 1000 may be performed by at least one processor (also referred to herein as the singular “processor”) of a management node or a leader management node. According to some example embodiments, the management node 112 of the first data center 110 may be the leader management node, and the method 1000 may be performed by the at least one processor of the management node 112 (e.g., the at least one processor of the MDCM server and/or the DCM server of the management node 112). According to some example embodiments, the management nodes 122 and 132 of the data centers 120 and 130, respectively, may be backup management nodes. The method 1000 may be initiated by the processor being allocated with (or by the processor allocating) one (e.g., a first data node) of a plurality of data nodes (e.g., a first plurality of data nodes) in the first data center as a master data node, at S1010. Likewise, the processor may be allocated with (or the processor may allocate, assign, etc.) another one (e.g., a second data node) of the plurality of data nodes in the first data center as the first backup data node, at S1020, and may be allocated with (or may allocate) one of a plurality of data nodes in the second data center (e.g., a second plurality of data nodes) as the second backup data node, at S1030. The first data center (e.g., the data center 110) and the second data center (e.g., the data center 120) may be located in different regions.

The processor may set the first mode or the second mode for the method of data replication (or duplication) between the master data node, the first backup data node, and the second backup data node, at S1040. According to some example embodiments, the processor may set a data replication mode between the master data node, the first backup data node and the second backup data node. According to some example embodiments, the data replication mode may be selected (e.g., by the processor based on, for example, an input from a user and/or administrator) from a set of modes including the first mode and the second mode. The first mode may be a data replication method that prioritizes data stability in the event of a failure over minimization (or reduction) of latency in providing service. The second mode may be the data replication method that prioritizes minimization (or reduction) of latency in providing service over data stability in the event of a failure.

The setting the first mode for the data replication method may include setting the first backup data node as a slave type and setting the second backup data node as a slave type. The data replication between each of the slave type backup data nodes and the master data node may be performed with the synchronous replication method, and each of the slave type backup data nodes may be included as a new master candidate for the master election that may be performed when the master data node fails.

If both the first backup data node and the second backup data node are set as the slave type, the master data node may be configured to transmit a replication log to the first backup data node and the second backup data node in response to receiving a request, and output a response associated with the request in response to (e.g., only in response to) receiving an acknowledgement (ACK) from both the first backup data node and the second backup data node.

In response to determining that the master data node fails while the first mode is set for the data replication method, the processor may automatically change one of the slave type first backup data node or the second backup data node to the new master data node without an administrator input. The automatically changing the node to a new master data node without administrator input may include, by the processor, assigning priority to the first backup data node in the master election, in response to determining that the first backup data node is a slave type data node located in the same data center as (or a similar data center to) the master data node and that the second backup data node is a slave type data node located in a different data center from the master data node.

While the first mode is set for the data replication method, the processor may receive an input for changing the data replication method from the first mode to the second mode. In response to receiving the input, the processor may set the second mode for the method of data replication between the master data node, the first backup data node, and the second backup data node.

The setting the second mode for the data replication method may include, by the processor, setting the first backup data node as the slave type and setting the second backup data node as the learner type. The data replication between the learner type backup data node and the master data node may be performed with the asynchronous replication method. In addition, the learner type backup data node may not be included as the new master candidate for the master election that may be performed when the master data node fails.

If the first backup data node is set as the slave type and the second backup data node is set as the learner type, in response to receiving a request, the master data node may be configured to transmit a replication log to the first backup data node and the second backup data node, receive an acknowledgement (ACK) from the first backup data node, and output a response associated with the request (in response to the ACK received from the first backup data node) regardless of whether an ACK is received from the second backup data node.

In response to determining that the master data node fails while the second mode is set for the data replication method, the processor may automatically change the slave type first backup data node to the new master data node without an administrator input. In addition, in response to determining that both the master data node and the slave type first backup data node fail while the second mode is set for the data replication method, the processor may transmit a message querying whether or not to change the learner type second backup data node to a new master data node. In this case, in response to receiving a request for changing the learner type second backup data node to a new master data node (e.g., in response to the transmitted message), the processor may change the learner type second backup data node to a new master data node.

The leader management node (e.g., the management node 112) may be connected to one or more backup management nodes (e.g., the management node 122 and/or 132), and the leader management node and the one or more backup management nodes may be located in different data centers. In response to the occurrence of a failure in the leader management node, one of the one or more backup management nodes may be changed to a new leader management node. The leader management node and one or more backup management nodes may be synchronized using the Raft Protocol.

Conventional devices and methods for managing data center failures (e.g., by performing a failover operation) perform data replication among data storage devices within a single data center. Such conventional devices and methods are susceptible to failures that affect the entire data center, such as, for example, fires, earthquakes, floods, etc. In the event of such a data center-wide failure, Internet-based services provided via the data center are interrupted and irreparable damage such as data loss may occur. Accordingly, the conventional devices and methods are insufficiently stable and/or reliable.

However, according to some example embodiments, improved devices and methods are provided for managing data center failures (e.g., by performing a failover operation). For example, the improved devices and methods may perform data replication among data nodes in different data centers located in different geographical regions. Accordingly, in the event of a data center-wide failure (e.g., a fire, earthquake, flood, etc.), a failover to a data node not affected by the failure may be quickly performed. Therefore, the improved devices and methods overcome the deficiencies of the conventional devices and methods to at least improve service stability and/or data reliability.

The flowchart illustrated in FIG. 10 and the above description are merely examples and may be implemented differently in some examples. For example, one or more operations may be omitted, the order of operations may be changed, one or more operations may be performed in parallel, or one or more operations may be repeatedly performed multiple times.

The method described above may be provided as a computer program stored in a non-transitory computer-readable recording medium for launch on a computer. The medium may be a type of medium that continuously stores a program executable by a computer, or temporarily stores the program for execution or download. In addition, the medium may be a variety of writing means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, a combination of hardware and firmware, a combination of hardware and software, or a combination thereof. Those skilled in the art will further appreciate that various illustrative logical blocks, modules, circuits, and algorithm operations described in connection with the disclosure herein may be implemented in electronic hardware, computer software, or combinations of both. To clearly illustrate this interchangeability of hardware and software, various illustrative components, blocks, modules, circuits, and operations have been described above generally in terms of their functionality. Whether such a function is implemented as hardware or software varies according to design requirements (or configurations) imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a non-transitory computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatuses. Such apparatuses may include PCs, network servers, and portable apparatuses.

Although the present disclosure has been described in connection with some examples herein, various modifications and changes may be made without departing from the scope of the present disclosure, which may be understood by those skilled in the art to which the present disclosure pertains. In addition, such modifications and changes should be considered in the scope of the claims appended herein.

1. A method for managing data center failures, the method being executed by one or more processors of a leader management node, and the method comprising:
allocating a first data node among a first plurality of data nodes a master data node, the first plurality of data nodes being in a first data center;
allocating a second data node among the first plurality of data nodes as a first backup data node;
allocating one among a second plurality of data nodes as a second backup data node, the second plurality of data nodes being in a second data center, and the first data center and the second data center being located in different regions; and
setting a data replication mode between the master data node, the first backup data node and the second backup data node, the data replication mode being selected from a set of modes including a first mode and a second mode.

2. The method according to claim 1, wherein the first mode prioritizes data stability over minimization of latency when providing a service in response to occurrence of a failure.

3. The method according to claim 1, wherein the setting comprises setting the data replication mode as the first mode including:
setting the first backup data node as a first slave type backup data node; and
setting the second backup data node as a second slave type backup data node, data replication between each of the first slave type backup data node and the second slave type backup data node with the master data node being performed based on synchronous replication, and each of the first slave type backup data node and the second slave type backup data node is included as a new master candidate for a master election performed in response to failure of the master data node.

4. The method according to claim 3, wherein the synchronous replication includes:
transmitting, by the master data node, a replication log to both the first backup data node and the second backup data node in response to receiving a request;
receiving, by the master data node, an acknowledgement (ACK) from each of the first backup data node and the second backup data node; and
outputting, by the master data node, a response associated with the request in response to receiving the ACK from each of the first backup data node and the second backup data node.

5. The method according to claim 3, further comprising:
automatically changing one of the first slave type backup data node or second slave type backup data node to a new master data node without an administrator input in response to determining that the master data node has failed while the data replication mode is set as the first mode.

6. The method according to claim 5, wherein the automatically changing includes assigning priority to the first backup data node in the master election in response to determining that
the first backup data node is set as the first slave type backup data node located in the same data center as the master data node, and
the second backup data node is set as the second slave type backup data node located in a data center different from the master data node.

7. The method according to claim 3, further comprising:
receiving an input for changing the data replication mode from the first mode to the second mode; and
setting the data replication mode to be the second mode in response to the receiving of the input.

8. The method according to claim 1, wherein the second mode prioritizes minimization of latency in providing a service over data stability in response to occurrence of a failure.

9. The method according to claim 1, wherein the setting comprises setting the data replication mode as the second mode including:
setting the first backup data node as a slave type backup data node; and
setting the second backup data node as a learner type backup data node.

10. The method according to claim 9, wherein data replication between the learner type backup data node and the master data node is performed based on asynchronous replication.

11. The method according to claim 10, wherein the asynchronous replication includes:
transmitting, by the master data node, a replication log to the first backup data node and the second backup data node in response to receiving a request;
receiving, by the master data node, an acknowledgement (ACK) from the first backup data node; and
outputting, by the master data node, a response associated with the request in response to the receiving of the ACK regardless of whether an ACK is received from the second backup data node.

12. The method according to claim 9, wherein the learner type backup data node is excluded as a new master candidate for a master election that is performed in response to a failure of the master data node.

13. The method according to claim 9, further comprising:
automatically changing the first backup data node to a new master data node without administrator input in response to determining that the master data node has failed while the data replication mode is set as the second mode.

14. The method according to claim 9, further comprising:
transmitting a message querying whether or not to change the second backup data node to a new master data node in response to determining that both the master data node and the first backup data node have failed while the data replication mode is set as the second mode.

15. The method according to claim 14, further comprising:
changing the second backup data node to a new master data node in response to receiving a corresponding request.

16. The method according to claim 1, wherein the leader management node is connected to one or more backup management nodes, the leader management node and the one or more backup management nodes being located in different data centers.

17. The method according to claim 16, wherein one of the one or more backup management nodes is changed to a new leader management node in response to occurrence of a failure in the leader management node.

18. The method according to claim 16, wherein the leader management node and the one or more backup management nodes are synchronized using a Raft Protocol.

19. A non-transitory computer-readable recording medium storing instructions that, when executed by one or more processors, cause performance of the method according to claim 1.

20. A management node comprising:
a memory storing one or more computer-readable programs; and
one or more processors connected to the memory and configured to execute the one or more computer-readable programs to cause the management node to
allocate a first data node among a first plurality of data nodes as a master data node, the first plurality of data nodes being in a first data center,
allocate a second data node among the first plurality of data nodes as a first backup data node,
allocate one among a second plurality of data nodes as a second backup data node, the second plurality of data nodes being in a second data center, and the first data center and the second data center being located in different regions, and
set a data replication mode between the master data node, the first backup data node and the second backup data node, the data replication mode being selected from a set of modes including a first mode and a second mode.
